(19) United States
(12) Patent Application Publication
(10) Pub. No.: US 2005/0159500 A1
(43) Pub. Date: Jul. 21, 2005

(54) Polyether esters as flame retardants for polyurethane flexible foams

(76) Inventors: Thorsten Dreier, Dusseldorf (DE); Rolf Roers, Bocholt (DE); Matthaus Gossner, Koln (DE); Sven Meyer-Ahrens, Leverkusen (DE)

Correspondence Address: BAYER MATERIAL SCIENCE LLC, 100 BAYER ROAD, PITTSBURGH, PA, 15205, US

(21) Appl. No.: 11/032,434

(22) Filed: Jan. 10, 2005

(30) Foreign Application Priority Data
Jan. 13, 2004 (DE) 10 2004 001 746.8

(51) Int. Cl. C08G 18/00

(52) U.S. Cl. 521/174

(57) ABSTRACT

Flexible polyurethane foams that satisfy the requirements of FMVSS 302 are produced by reacting a polyisocyanate with a polyol component that includes: (1) from 90 to 99 parts by weight of a polyether polyol having an OH value of from 20 to 200 mg KOH/g and functionality of from 2 to 4 and (2) from 1 to 10 parts by weight of a polyether ester polyol having an OH value of from 150 to 450 mg KOH/g and a functionality of from 2 to 3 in the presence of a blowing agent, catalyst and stabilizer. The foams thus produced are useful as cushioning for furniture and automotive applications.

### BACKGROUND OF THE INVENTION

The present invention relates to flexible polyurethane foams that meet the requirements of Federal Motor Vehicle Safety Standard 302 (“FMVSS 302”) and to processes for producing and using such foams.

Flexible polyurethane (“PUR”) foams are produced by reacting one or more polyols with one or more organic polyisocyanates in the presence of one or more blowing agents and catalysts. Such foams are used in a wide variety of applications, for example, as carpet underlay, interlinings, mattresses, cushions, upholstery material, insulating material, etc. Foams that are produced from polyisocyanates and polyester polyols with suitable auxiliaries and additives which have a bulk density of about 35 kg/m³ fulfill the requirements of the Federal Motor Vehicle Safety Standard (FMVSS) 302. Such ester PUR foams are, however, inferior to the known ether PUR foams with respect to a number of properties. For example, the open-pore character of the ester PUR foams is poorer, their elasticity is lower and their resistance to moisture and heat is low in comparison to ether PUR foams.

On the other hand, conventional ether foams having a bulk density of about 35 kg/m³ do not fulfill the requirements of the FMVSS 302 standard. In order to eliminate this disadvantage and, in addition, to be able to achieve lower bulk densities, it is usual to produce ether PUR foams by adding suitable flame retardants so that they fulfill the requirements of the test standard. However, such flame retardants also have disadvantages. In particular, halogen-free flame retardants are frequently expensive and less expensive flame retardants result in increased total emissions of the foams. An equally undesirable side effect of flame retardants is their action as plasticizers.

It would therefore be desirable to find a way of rendering ether PUR foams flame-retardant without adding large amounts of flame retardants. It seems obvious to add polyester polyols in small amounts to the standard polyether polyols to increase the flame resistance. Surprisingly, however, the flammability of the foams obtained in this way is higher than that of pure polyether flexible foam.

### SUMMARY OF THE INVENTION

It has now been found that, if special polyether esters are used, the desired flame-retardant action occurs and the foams obtained pass the FMVSS 302 test. In addition, it was found that the content of flame retardants can be reduced with respect to pure standard polyether flexible foams, with the result that their disadvantages are reduced.

### DETAILED DESCRIPTION OF THE INVENTION

The present invention relates to flexible polyurethane foams that fulfill the requirements of FMVSS 302 obtainable by reacting
a) one or more organic and/or modified polyisocyanates with
b) a polyol component that includes:
   b1) 90 to 99 parts by weight, based on total weight of component b), of at least one polyether polyol having an OH value of 20 to 200 mg KOH/g and a functionality of 2 to 4 and
   b2) 1 to 10 parts by weight, based on total weight of component b), of at least one polyether ester polyol having an OH value of 150 to 450 mg KOH/g and a functionality of 2 to 3,

in the presence of
c) water and/or another blowing agent,
d) a catalyst,
e) a stabilizer, optionally
f) a flame retardant and, optionally,
g) further auxiliaries and additives.

Suitable organic and/or modified polyisocyanates a) are in principle known to the person skilled in the art and are described, for example, in “Kunststoffhandbuch” (“Plastics Manual”), volume 7, “Polyurethanes”, Chapter 5.1. Examples of suitable polyisocyanates include: aliphatic, cycloaliphatic, araliphatic, aromatic and heterocyclic polyisocyanates of the formula Q(NCO)ₙ, in which n=2-4, preferably 2, and Q is an aliphatic hydrocarbon radical containing 2-18, preferably 6-10 carbon atoms; a cycloaliphatic hydrocarbon radical containing 4-15, preferably 5-10 carbon atoms; an aromatic hydrocarbon radical containing 6-15, preferably 6-13 carbon atoms; or an araliphatic hydrocarbon radical containing 8-15, preferably 8-13 carbon atoms. Specific examples of such isocyanates are described in DE-OS 2 832 253, pages 10-11.

Particularly preferred, as a rule, are the industrially easily accessible polyisocyanates, such as 2,4- and 2,6-toluene diisocyanate, and also any mixtures of these isomers (“TDI”); polyphenyl polymethylene polyisocyanates, such as those that are prepared by aniline/formaldehyde condensation and subsequent phosgenation (“raw MDI”); and polyisocyanates (“modified isocyanates”) containing carbodiimide groups, urethane groups, allophanate groups, isocyanate groups, urea groups or biuret groups, in particular those modified isocyanates that are derived from 2,4- and/or 2,6-toluene diisocyanate or from 4,4′- and/or 2,4-diphenylmethane diisocyanate.

As already mentioned, particularly preferred is toluene diisocyanate, most preferably, toluene diisocyanate having a content of 80 wt % of 2,4- and 20 wt % of 2,6-isomers (TDI-80), and toluene diisocyanate having a content of 65 wt % of 2,4- and 35 wt % of 2,6-isomers (TDI-65).

Suitable polyether polyols b1) have an OH value ranging from 20 to 200, preferably from 42 to 60, and a functionality of 2 to 4, preferably 2 to 3. Polyether polyols containing predominantly secondary OH groups are particularly preferred. Suitable polyether polyol initiators are compounds containing reactive hydrogen atoms, such as water, alcohols, ammonia and/or amines. Examples of such initiators include: ethylene glycol, 1,3-propylene glycol, 1,2-propylene glycol, trimethylolpropane, glycerol, 4,4′-dihydroxydiphenylpropane, aniline, ethanolamine and/or ethylendiamine. Preferably, trimethylolpropane and/or glycerol are used as initiators.

According to the invention, polyether polyols that contain exclusively or very predominantly secondary OH groups (more than 85 wt % based on all the OH groups present in the polyether polyol) are preferred.

Furthermore, the filler-containing polyols known to those skilled in the art may also be used. Dispersions of higher-molecular-weight hydroxyl compounds that contain polymers and that have been produced by reacting (a) mono- and/or polyisocyanates with polyamides containing primary and/or secondary amino groups and/or hydrazines and/or alkanolamines in (b) a compound containing 1 to 8 primary and/or secondary hydroxyl groups and having a molecular weight of 400 to 10,000 g/mol are preferred. Also suitable for use in the practice of the present invention are dispersions of reaction products of polyisocyanates and alkanolamines in polyethers and dispersions of homo- and copolymers of unsaturated monomers, such as styrene or acrilonitrile in polyethers (so-called “polymer polyols”).

Suitable polyether ester polyols b2) are preferably alkoxylation products of oligoesters and polyesters of aromatic and aliphatic dicarboxylic acids and dicarboxylic acid derivatives, such as, for example, anhydrides containing terminal groups that are reactive towards isocyanates. Polyether ester polyols (or polyester ether polyols) can be produced by systematic synthesis, for example by alkoxylation of carboxylic acids or carboxylic anhydrides or polyesters, or by molecule-doubling condensation of OH-terminated polyesters. These compounds may likewise be reacted with epoxides by known methods.

The polyether ester polyols b2) used in the practice of the present invention may contain as initiator molecules, for example, adipic acid, maleic acid, fumaric acid, phthalic acid, terephthalic acid, isophthaiic acid, tetrahydrophthalic acid, halogenated phthalic and tetrahydrophthalic acids and the like. Preferred carboxylic acids are adipic acid, maleic acid, fumaric acid and/or their derivatives. Phthalic acid, terephthalic acid and isophthalic acid and/or their derivatives are particularly preferred. The initiator molecules used in addition to carboxylic acids or carboxylic acid derivatives are secondary products of ethylene oxide and propylene oxide, such as, for example, ethylene glycol, diethylene glycol, triethylene glycol, 1,2-propylene glycol, dipropylene glycol or the diprimary alcohols, such as 1,4-butanediol, 1,6-hexanediol, neopentyl glycol, 1,3-butanediol or branched triol components, such as trimethylolpropane, trimethylolethane, glycerol and also long-chain trihydroxyl compounds. The polyether ester polyols b2) have an OH value of from about 150 to about 450 mg KOH/g and a functionality of from about 2 to about 3.

The polyether ester polyols b2) are added to the polyol component b) in an amount of from 1 to 10 parts by weight, preferably from 2 to 7 parts by weight, most preferably from 3 to 5 parts by weight, based on the total weight of the component b).

Water and/or other chemical or physical blowing agents known to the person skilled in the art may be used as the blowing agent c) in the practice of the present invention. Examples of suitable blowing agents include methylene chloride, diethyl ether, acetone, alkanes, such as pentane, isopentane and/or cyclopentane and/or inorganic blowing agents such as air and CO₂. If water is used as the blowing agent, it is preferably added in an amount of from 1 to 6 parts by weight, based on the total weight of the component b).

Suitable flame retardants f) are known to the person skilled in the art and are described, for example, in “Kunststoffhandbuch” (“Plastics Manual”), volume 7, “Polyurethanes”, Chapter 5.1. Preferred flame retardants f) are halogen-free phosphorus compounds. Examples of such flame retardants include: triaryl and trialkyl phosphates, triaryl arid trialkyl phosphonates and tetraalkyl diphosphonate compounds. Particularly preferred flame retardants are reactive phosphorus polyols, such as those marketed under the trade names Exolit® OP 550 and Exolit® OP 560 by Clariant International Ltd,. CH-4132 Muttenz.

The flame retardant f) is preferably used in an amount of from 2 to 8 parts by weight, particularly preferably from 3 to 6 parts by weight, based on the total weight of the component b).

Catalysts d), stabilizers e), and further auxiliaries and additives g) useful for the production of polyurethane flexible foams in accordance with the present invention are known in principle to the person skilled in the art and are described, for example, in “Kunststoffhandbuch” (“Plastics Manual”), volume 7, “Polyurethanes”, Chapter 5.1.

Preferred catalysts are amine compounds and/or metal compounds, in particular heavy-metal salts and/or organometallic compounds. In particular, known tertiary amines with or without organic metallic compounds are used as catalysts. Suitable organic metallic compounds are, for example, tin compounds, such as tin(II) salts of organic carboxylic acids (for example, tin(II) acetate, tin(II) octoate, tin(II) ethylhexanoate and tin(II) laurate) and the dialkyltin(IV) salts of organic carboxylic acids (for example, dibutyltin diacetate, dibutyltin dilaurate, dibutyltin maleate and dioctyltin diacetate). Examples of suitable organic amine catalysts include: triethylamine, 1,4-diazabicyclo[2,2,2]octane, tributylamine, dimethylbenzylamine, N,N,N′,N′-tetramethylethylendiamine, N,N,N′,N′-tetra-methylbutanediamine, N,N,N′,N′-tetramethylhexane-1,6-diamine, and dimethylcyclohexylamine. The catalysts may be used individually or in the form of a mixture.

Foam stabilizers suitable for use in the practice of the present invention are, in particular, polyether siloxanes, especially those which are water-insoluble. These compounds are generally a combination of a copolymer of ethylene oxide and propylene oxide with a polydimethylsiloxane radical. Water-soluble foam stabilizers are described, for example, in U.S. Pat. Nos. 2,834,748, 2,917,480 and 3,629,308; however, water soluble foam stabilizers are unsuitable for producing high resilience (HR) foams.

The foams produced in accordance with the invention are normally produced by vigorously blending one component made up of the di- or polyisocyanate a) and a second component which is a mixture of the other reactants and additives by means of a suitable standard mechanical device. The foams may be produced both continuously, for instance on a conveyor-belt installation, and batchwise. The production of flexible foams is known in principle to the person skilled in the art and is described, for example, in G. Oertel (Ed.), “Kunststoff-Handbuch”, (“Plastics Manual”) volume VII, Carl Hanser Verlag, 3^{rd} edition, Munich 1993, pages 193-220.

The “index”, a concept very frequently used in the production of polyurethane foams, conveys something about the, degree of crosslinking of a foam. It is defined as the ratio of the isocyanate groups to the isocyanate-reactive groups in the reaction mixture multiplied by 100. Preferably, the foams produced in accordance with the present invention are produced at an index of from 80 to 120, preferably, from 90 to 115. The bulk density of the foams produced is preferably from 15 kg/m³ to 55 kg/m³, most preferably, from 20 kg/m³ to 50 kg/m³.

The flexible polyurethane foams according to the invention are suitable, in particular, for use as lying, sitting and upholstery material and also for the internal fittings of motor vehicles.

Having thus described the invention, the following Examples are given as being illustrative thereof. All parts and percentages given therein are parts and percentages by weight, unless otherwise indicated.

### EXAMPLES

Stock Materials

Polyols

Polyol A: PO/EO adduct to a mixture of glycerol and propylene glycol, OH value 56 (commercially available under the name Arcol® 1105, from Bayer AG)

Polyol B: Polyester polyol based on adipic acid, phthalicanhydride and ethylene glycol, OH value 64 (commercially available under the name Desmophen® PEP 175 A from Bayer AG)

Polyol C: Polyester polyol based on adipic acid, isophthalic acid and diethylene glycol, OH value 112 (commercially available under the name Desmophen® VP.LS 2782 from Bayer AG)

Polyol D: EO adduct to a mixture of phthalicanhydride, diethylene glycol and ethylendiamine, OH value 310, functionality 2 (commercially available under the name Desmophen® VP.PU 1431 from Bayer AG)

Polyol E: PO adduct to a mixture of phthalicanhydride, diethylene glycol, sorbitol and ethylendiamine, OH value 435, functionality 2.8 (commercially available under the name Desmophen® VP.PU 20AP74 from Bayer AG)

Flame Retardant

FS 1: Reactive phosphorus polyol, functionality about 2 (commercially available under the name Exolit® OP550 from Clariant International Ltd)

FS 2: Reactive phosphorus polyol, functionality about 2 (commercially available under the name Exolit® OP560 from Clariant International Ltd)

FS 3: Triphenyl phosphate

Catalysts and Stabilizers

Cat 1: A mixture of BDMAEE/DPG in a ratio of 70/30 (commercially available under the name Niax® A1 from OSi Specialties)

Cat 2: A mixture of triethylendiamine/DPG in a ratio of 33/67 (commercially available under the name Dabco® 33LV from Air Products)

Cat 3: Zinc(II) octoate

Stabilizer: Silicone stabilizer (commercially available under the name Tegostab® B 8232 from Goldschmidt AG)

The polyols were introduced into a cardboard beaker having an aluminum base in the amounts indicated in the Table. Water, stabilizer, optionally flame retardant and the Catalysts 1 and 2 were consecutively weighed out into the polyols in the amounts indicated in the Table. The mixture was then stirred for 25 seconds at 1200 rev/min. Activator 3 was then added in the amount indicated in the Table and blended for 5 seconds at the same stirring speed. The amount of TDI indicated in the Table was then added in one shot and blending was continued for 7 seconds. The reaction mixture was then poured into a cardboard mold having a volume of 20×20×14 cm and foamed. The properties of the flexible polyurethane foams produced are listed in the Table.

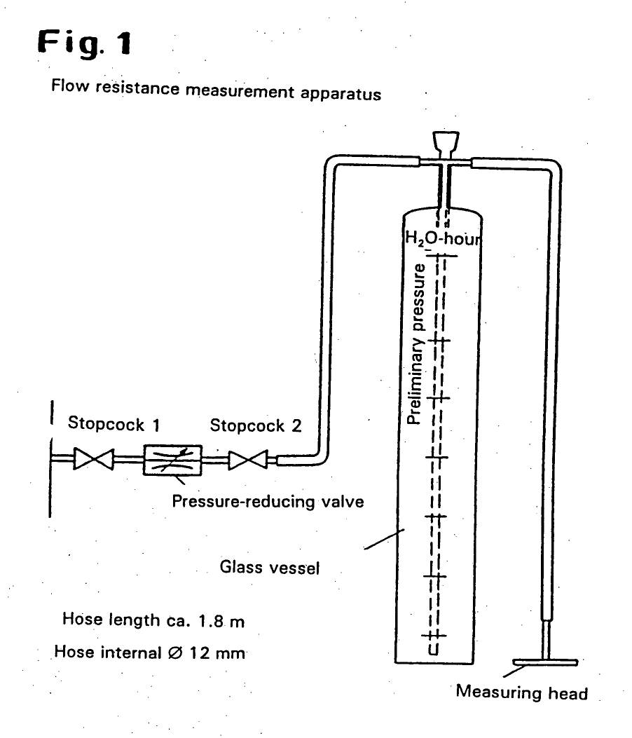

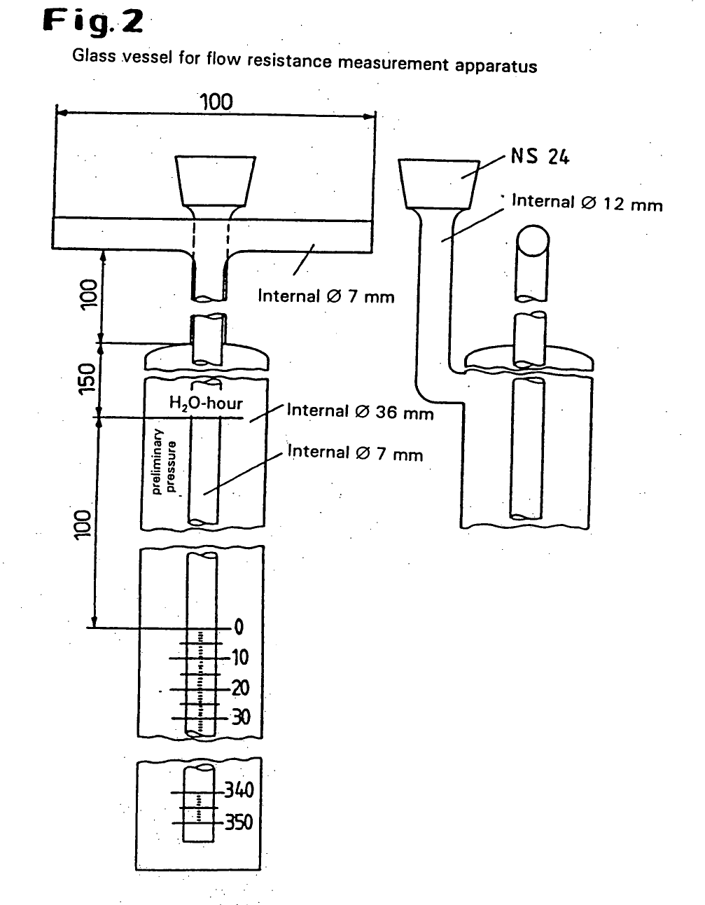

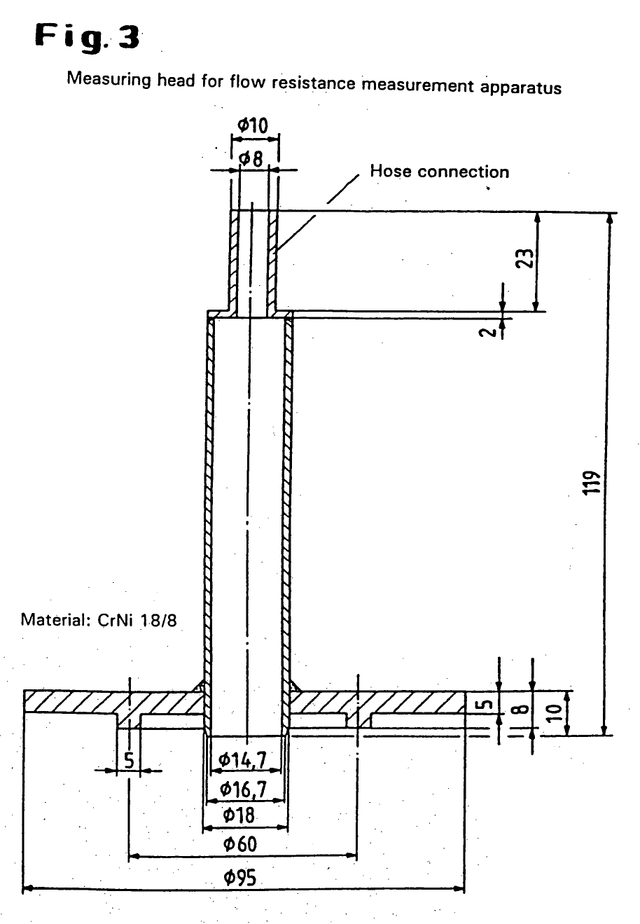

The open-cell character was determined by measuring the flow resistance, as described in DE-A 199 28 156 in example 12 using the apparatus illustrated in FIGS. 1-3 of that disclosure.

| | Example No. | | | | |
|---|---|---|---|---|---|
| | 1 | 2 | 3 | | |
| | Comparison | Comparison | Comparison | 4 | 5 |
| Polyol A, pbw | 100.00 | 95.00 | 95.00 | 95.00 | 95.00 |
| PoIyol B, pbw | | 5.00 | | | |
| Polyol C, pbw | | | 5.00 | | |
| Polyol D, pbw | | | | 5.00 | |
| Polyol E, pbw | | | | | 5.00 |
| Water, pbw | 3.00 | 3.40 | 3.40 | 3.33 | 3.16 |
| Stabilizer, pbw | 0.80 | 1.20 | 1.20 | 1.20 | 1.20 |
| Cat. 1, pbw | 0.10 | 0.08 | 0.08 | 0.15 | 0.08 |
| Cat. 2, pbw | | 0.08 | 0.08 | 0.08 | 0.08 |
| Cat. 3, pbw | 0.13 | 0.25 | 0.22 | 0.13 | 0.1 |
| TDI 80, pbw | 40.9 | 45.4 | 45.8 | 30.7 | 22.6 |
| TDI 65, pbw | — | — | — | 15.4 | 22.6 |
| Index | 108 | 106.5 | 106.5 | 106.5 | 106.5 |
| Bulk density | 33.8 | 31.4 | 32.1 | 29.9 | 33.0 |
| [kg/m³] | | | | | |
| Compressive | 3.9 | 4.4 | 4.2 | 4.4 | 4.4 |
| strength 40% | | | | | |
| [kPa] | | | | | |
| Open-cell char. | 118 | 224 | 196 | 187 | 177 |
| [mm Ws] | | | | | |
| Burned length [mm] | 100 | 100 | 100 | 100 | 100 |
| Burning time [s] | 35 | 10 | 10 | 65 | 63 |
| Burning rate [mm/s] | 2.9 | 10 | 10 | 1.5 | 1.6 |
| FMVSS 302 | no | no | no | yes* | yes* |

| | Example No. | | | | | | | |
|---|---|---|---|---|---|---|---|---|
| | 6 | 7 | | 9 | 10 | | 12 | |
| | Comp. | Comp. | 8 | Comp. | Comp. | 11 | Comp. | 13 |
| Polyol A, pbw | 100.00 | 100.00 | 95.00 | 100.00 | 100.00 | 95.00 | 100.00 | 95.00 |
| Polyol D, pbw | | | 5.00 | | | 5.00 | | 5.00 |
| FS 1, pbw | 3.50 | 2.50 | 2.50 | | | | | |
| FS 2, pbw | | | | 6.00 | 4.00 | 4.00 | | |
| FS 3, pbw | | | | | | | 5.00 | 5.00 |
| Water, pbw | 3.50 | 3.50 | 3.50 | 3.50 | 3.35 | 3.40 | 3.00 | 3.00 |
| Stabilizer, pbw | 1.00 | 1.00 | 1.00 | 0.80 | 1.25 | 1.20 | 1.20 | 1.20 |
| Cat. 1, pbw | 0.10 | 0.10 | 0.10 | 0.17 | 0.09 | 0.19 | 0.08 | 0.08 |
| Cat. 2, pbw | 0.20 | 0.20 | 0.20 | | 0.18 | 0.05 | 0.08 | 0.08 |
| Cat. 3, pbw | 0.15 | 0.20 | 0.15 | 0.13 | 0.20 | 0.13 | 0.23 | 0.13 |
| TDI 80, pbw | 46.1 | 45.7 | 23.9 | 40.6 | 23.3 | 24.6 | 40.4 | 28.4 |
| TDI 65, pbw | | | 23.9 | 10.1 | 23.2 | 24.6 | | 14.2 |
| Index | 105 | 105 | 105 | 108 | 106.5 | 106.5 | 106.5 | 106.5 |
| Bulk density [kg/m³] | 30.0 | 29.2 | 30.5 | 30.6 | 30.5 | 30.5 | 31.4 | 33.4 |
| Compressive strength | 3.0 | 3.5 | 3.9 | 3.7 | 3.6 | 3.3 | 3.0 | 3.6 |
| 40% [kPa] | | | | | | | | |
| Open-cell char. [mm Ws] | 111 | 224 | 304 | 116 | 166 | 112 | 70 | 140 |
| Burned length [mm] | 80 | 35 | 30 | | 10 | | 100 | |
| Burning time [s] | 60 | 20 | 20 | | 10 | | 63 | |
| Burning rate [mm/s] | 1.3 | 1.8 | 1.5 | | 1.0 | | 1.6 | |
| FMVSS 302 | SE | SE | SE | SE | SE | SE | yes* | SE |

| | Example No. | | | | | | | | |
|---|---|---|---|---|---|---|---|---|---|
| | 14 | 15 | 16 | 17 | 18 | 19 | 20 | 21 | 22 |
| Polyol A, pbw | 99.00 | 98.00 | 97.00 | 96.00 | 94.00 | 93.00 | 92.00 | 91.00 | 90.00 |
| Polyol D, pbw | 1.00 | 2.00 | 3.00 | 4.00 | 6.00 | 7.00 | 8.00 | 9.00 | 10.00 |
| Water, pbw | 3.00 | 3.00 | 3.00 | 3.00 | 3.00 | 3.00 | 3.00 | 3.00 | 3.00 |
| Stabilizer, pbw | 1.20 | 1.20 | 1.20 | 1.20 | 1.20 | 1.20 | 1.20 | 1.20 | 1.20 |
| Cat. 1, pbw | 0.08 | 0.08 | 0.08 | 0.08 | 0.08 | 0.08 | 0.08 | 0.08 | 0.08 |
| Cat. 2, pbw | 0.08 | 0.08 | 0.08 | 0.08 | 0.08 | 0.08 | 0.08 | 0.08 | 0.08 |
| Cat. 3, pbw | 0.24 | 0.22 | 0.21 | 0.20 | 0.18 | 0.16 | 0.14 | 0.13 | 0.13 |
| TDI 80, pbw | 27.2 | 27.5 | 27.8 | 28.1 | 28.7 | 28.9 | 29.2 | 29.5 | 29.8 |
| TDI 65, pbw | 13.6 | 13.8 | 13.9 | 14.0 | 14.3 | 14.5 | 14.6 | 14.7 | 14.9 |
| Index | 106.5 | 106.5 | 106.5 | 106.5 | 106.5 | 106.5 | 106.5 | 106.5 | 106.5 |
| Bulk density kg/m³] | 31.4 | 32.6 | 31.9 | 32.2 | 32.0 | 33.0 | 31.7 | 34.0 | 30.7 |
| Compressive strength | 3.6 | 4.0 | 4.0 | 4.3 | 4.6 | 5.0 | 5.2 | 5.1 | 5.0 |
| 40% [kPa] | | | | | | | | | |
| Open-cell char. [mm s] | 175 | 162 | 197 | 263 | 316 | 350 | 350 | 350 | |
| Burned length [mm] | 100 | 100 | 100 | 100 | 100 | 100 | 100 | 100 | 100 |
| Burning time [s] | 55 | 55 | 70 | 65 | 72 | 72 | 70 | 75 | |
| Burning rate [mm/s] | 1.8 | 1.8 | 1.4 | 1.5 | 1.4 | 1.4 | 1.4 | 1.3 | |
| FMVSS 302 | no | no | yes* | yes* | yes* | yes* | yes* | yes* | |

*= The requirements according to FMVSS 302 were fulfilled over the burned length
pbw = parts by weight

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A flexible polyurethane foam satisfying the requirements of FMVSS 302 comprising the reaction product of
a) an organic and/or modified polyisocyanate with
b) a polyol component comprising:
1) from about 90 to about 99 parts by weight of a polyether polyol having an OH value of from about 20 to about 200 mg KOH/g and a functionality of 2 to 4 and
2) from about 1 to about 10 parts by weight of a polyether ester polyol having an OH value of from about 150 to about 450 mg KOH/g and a functionality of from about 2 to about 3,
in the presence of
c) water and/or another blowing agent,
d) a catalyst,
e) a stabilizer,
f) optionally, a flame retardant and,
g) optionally, an auxiliary and/or additive which is different from c), d), e) and f).

2. The flexible polyurethane foam of claim 1 produced in the presence of a flame retardant comprising a halogen-free phosphorus compound containing a phosphoric acid triaryl and/or a phosphoric acid trialkyl and/or a tetraalkyl diphosphonate compound.

3. The flexible polyurethane foam of claim 2 in which the flame retardant is used in an amount of from 2 to 8 parts by weight, based on the total weight of the components b) to g).

4. The flexible polyurethane foam of claim 3 in which toluene diisocyanate is organic polyisocyanate a).

5. The flexible polyurethane foam of claim 2 in which toluene diisocyanate is organic polyisocyanate a).

6. The flexible polyurethane foam of claim 1 in which toluene diisocyanate is organic polyisocyanate a).

7. The flexible polyurethane foam of claim 1 in which from 1 to 6 parts by weight of water, based on the total weight of components b) to g) are used as blowing agent c).

8. The flexible polyurethane foam of claim 2 in which from 1 to 6 parts by weight of water, based on total weight of components b) to g) are used as blowing agent c).

9. The flexible polyurethane foam of claim 3 in which from 1 to 6 parts by weight of water, based on total weight of components b) to g) are used as blowing agent c).

10. An internal fitting for a motor vehicle comprising the flexible polyurethane foam of claim 1.

11. An internal fitting for a motor vehicle comprising the flexible polyurethane foam of claim 8.

12. An internal fitting for a motor vehicle comprising the flexible polyurethane foam of claim 7.

13. Cushioning for the interior of a motor vehicle comprising the flexible polyurethane foam of claim 1.
